(19) United States
(12) Patent Application Publication
(10) Pub. No.: US 2020/0285255 A1
(43) Pub. Date: Sep. 10, 2020

(54) METHOD AND APPARATUS FOR PROVIDING DRONE-BASED ALERTING OF MOVEMENT OF A PART OF A VEHICLE INTO A PATH OF TRAVEL

(71) Applicant: HERE Global B.V., Eindhoven (NL)

(72) Inventors: Frank KOZAK, Chicago, IL (US); Chris DOUGHERTY, Highland Park, IL (US)

(73) Assignee: HERE Global B.V., Eindhoven (NL)

(21) Appl. No.: 16/297,066

(22) Filed: Mar. 8, 2019

(51) Int. Cl. G05D 1/12; B64C 39/02; G05D 1/10

(52) U.S. Cl. CPC G05D 1/12; B64C 2201/12; G05D 1/101; B64C 39/024

(57) ABSTRACT

A method, apparatus and computer program product are provided to utilize an unmanned drone to warn a bicyclist or another vehicle of a part of a vehicle moving into the path of travel of the bicyclist or the other vehicle. In the context of a method, at least one event indicative of a door of a vehicle being opened is detected. Responsive to detection of the at least one event, the method also includes causing the drone to take an action regarding the door of the vehicle being opened into the path of the bicyclist or the other vehicle.

### TECHNOLOGICAL FIELD

An example embodiment relates generally to the use of unmanned drones to provide an alert, such as to a bicyclist, an occupant of a parked vehicle or the driver of another vehicle, and, more generally, to using a drone to take an action regarding a part of a vehicle moving into a path of travel of a bicyclist or another vehicle.

### BACKGROUND

Vehicles frequently park alongside or immediately adjacent to a lane of traffic. For example, a road may include one or more lanes of traffic extending in each of two opposed directions. Along one or both opposed sides of the road, vehicles may be permitted to park, at least during certain days and/or certain times of days. As such, traffic, such as both vehicular traffic and bicyclists, passes adjacent to the parked vehicles.

As a result of the proximity of the parked vehicles to the lanes of traffic, a parked vehicle may create issues for the traffic passing nearby. For example, an occupant of a parked vehicle may open the door of the parked vehicle into a lane of traffic. A bicyclist or another vehicle traveling along the road may then strike the open door, thereby potentially damaging the bicycle and/or the vehicles and also subjecting the bicyclist and/or the occupant of the vehicle to injury.

Alternatively, a bicyclist or another vehicle traveling along the road may swerve away from the parked vehicle in response to the sudden opening of the door of the parked vehicle. Although this evasive maneuver may avoid the open door, the bicyclist or other vehicle may advertently swerve into another lane of traffic and, as such, be involved in a traffic accident in instances in which other vehicles are in the other lane of traffic.

Parked vehicles may create other types of issues for a bicyclist and other vehicles traveling along the road adjacent to the parked vehicle. For example, the driver of the vehicle that has been parked along a road may cause the vehicle to pull out from the parking space and into a lane of traffic. Even in instances in which the driver of the vehicle that has been parked checks for oncoming traffic, a bicyclist or other vehicles approaching the parked vehicle may be difficult to see in light of the relative position of the parked vehicle to the path of travel the bicyclist or other vehicle. As such, the driver of a vehicle that has been parked may cause the vehicle to be pulled out from a parking space into a lane of traffic in front of an approaching bicyclist or other vehicle, thereby creating an obstacle for the bicyclist or other vehicle. In some instances, the bicyclist or other vehicle may collide with the vehicle that was previously parked and that has now pulled out of the parking space and into the lane of traffic, while in other instances, the bicyclist or the other vehicle may take evasive action by swerving into another lane of traffic or coming to an abrupt halt in order to avoid the vehicle that was previously parked and that has now pulled out of the parking space and into the lane of traffic. Such evasive actions taken by the bicyclist or the other vehicle create the possibility of a traffic accident with yet another vehicle traveling along the road.

### BRIEF SUMMARY

A method, apparatus and computer program product are provided in accordance with an example embodiment in order to detect at least one event indicative of a part of a vehicle moving into the path of travel of a bicyclist or other vehicle and, in response to the detection the at least one event, to cause drone to take an action, such as by being positioned relative to the vehicle so as to provide an indication regarding movement of the vehicle into the path of travel of the bicyclist or other vehicle, providing a warning that the part of the vehicle is moving into the path of travel of the bicyclist or other vehicle or preventing the part of the vehicle from moving into the path of travel of the bicyclist or other vehicle. Based upon the indication provided by the drone, the bicyclist, the driver of the other vehicle and/or the driver of the vehicle that was previously parked may be forewarned such that evasive action may be taken, if necessary, at an earlier stage and in a more calculated manner so as to reduce the risk of a traffic accident. In one embodiment, a method, apparatus and computer program product are provided to detect at least one event indicative of a door of a vehicle being opened, while in another embodiment, a method, apparatus and computer program product are provided in order to detect a vehicle pulling from a stationary position out into a lane of travel. In either embodiment, a drone may be positioned relative to the vehicle responsive to the detection of the at least one event so as to provide an indication of the door of the vehicle being opened or the vehicle subsequently pulling out into the lane of travel.

In an example embodiment, a method is provided for detecting at least one event indicative of a part of a vehicle moving into a path of a bicyclist and, responsive to detection of the at least one event, causing a drone to be positioned relative to the vehicle so as to provide an indication regarding the vehicle moving into the path of the bicyclist. In relation to detecting the at least one event, the vehicle has a speed that is no greater than a predefined threshold.

The method of an example embodiment also includes determining that the bicyclist is approaching the vehicle and determining that the vehicle has a speed that is no greater than the predefined threshold. In this example embodiment, the detection of the at least one event is responsive to determinations that the bicyclist is approaching the vehicle and that the vehicle has a speed that is no greater than the predefined threshold.

In one embodiment, the method detects the at least one event by detecting the at least one event indicative of a door of the vehicle being opened. In this regard, the at least one event indicative of the door of the vehicle being opened includes detecting the at least one event selected from the group consisting of: a person being onboard the vehicle, a transmission of the vehicle being in park, an engine of the vehicle being off, the vehicle having come to a halt within a first predefined period of time, a part of the vehicle being indicative of having been recently operated, lettering or signage on the vehicle indicative of the vehicle being a taxi, and a medallion, decal or a sign carried by the vehicle indicative of the vehicle providing ride share services. In another embodiment, the method detects the at least one event by detecting the at least one event indicative of the vehicle subsequently pulling out into path of the bicyclist. In this regard, the at least one event indicative of the vehicle subsequently pulling out into the path of the bicyclist includes detecting the at least one event selected from the group consisting of: a person being onboard the vehicle, a transmission of the vehicle being in gear, an engine of the vehicle running, brakes of the vehicle having been released, a steering wheel of the vehicle having been moved within a first predefined period of time, a wheel of the vehicle having been moved within the first predefined period of time and a person having entered the vehicle within a second predefined period of time.

The method of an example embodiment also includes causing the drone to move along with the bicyclist. While the drone moves along with the bicyclist, the method includes identifying one or more stationary vehicles along a route of the bicyclist. Responsive to identifying one or more stationary vehicles, the method includes causing the drone to move further in advance of the bicyclist in order to detect the at least one event. In this example embodiment, the method may cause the drone to move further in advance of the bicyclist by causing the drone to travel alongside the one or more stationary vehicles and by causing a first alert to be provided regarding the one or more stationary vehicles in advance of the bicyclist. The method of this example embodiment may also detect, while the drone travels alongside the one or more stationary vehicles, a first type of event indicative of a door of the one or more stationary vehicles being subsequently opened and cause a second alert, different than the first alert, to be provided in response to detection of the first type of event. Additionally, the method of this example embodiment may detect, while the drone travels alongside the one or more stationary vehicles, a second type of event indicative of the door of the one or more stationary vehicles being opened and cause a third alert, different than the first and second alerts, to be provided in response to detection of the second type of event. The method of an example embodiment also includes determining that the bicyclist has passed the vehicle and, responsive to a determination that the bicyclist has passed the vehicle, causing the drone to discontinue its positioning relative to the vehicle.

In another example embodiment, an apparatus is provided that includes at least one processor and at least one non-transitory memory including computer program code instructions stored therein with the computer program code instructions configured to, when executed by the at least one processor, cause the apparatus at least to detect at least one event indicative of a part of a vehicle moving into a path of a bicyclist and, responsive to detection of the at least one event, cause an unmanned drone to be positioned relative to the vehicle so as to provide an indication regarding the vehicle moving into the path of the bicyclist. In relation to detecting the at least one event, the vehicle has a speed that is no greater than a predefined threshold.

The apparatus of an example embodiment also includes computer program code instructions configured to determine that the bicyclist is approaching the vehicle and computer program code instructions configured to determine that the vehicle has a speed that is no greater than the predefined threshold. In this example embodiment, the detection of the at least one event is responsive to determinations that the bicyclist is approaching the vehicle and that the vehicle has a speed that is no greater than the predefined threshold.

In one embodiment, the computer program code instructions configured to detect the at least one event include computer program code instructions configured to detect the at least one event indicative of a door of the vehicle being opened. In this regard, the at least one event indicative of the door of the vehicle being opened includes detecting the at least one event selected from the group consisting of: a person being onboard the vehicle, a transmission of the vehicle being in park, an engine of the vehicle being off, the vehicle having come to a halt within a first predefined period of time, a part of the vehicle being indicative of having been recently operated, lettering or signage on the vehicle indicative of the vehicle being a taxi, and a medallion, decal or sign carried by the vehicle indicative of the vehicle providing ride share services. In another embodiment, the computer program code instructions configured to detect the at least one event include computer program code instructions configured to detect the at least one event indicative of the vehicle subsequently pulling out into path of the bicyclist. In this regard, the at least one event indicative of the vehicle subsequently pulling out into the path of the bicyclist includes detecting the at least one event selected from the group consisting of: a person being onboard the vehicle, a transmission of the vehicle being in gear, an engine of the vehicle running, brakes of the vehicle having been released, a steering wheel of the vehicle having been moved within a first predefined period of time, a wheel of the vehicle having been moved within the first predefined period of time and a person having entered the vehicle within a second predefined period of time.

The apparatus of an example embodiment also includes computer program code instructions configured to cause the drone to move along with the bicyclist. The apparatus of this example embodiment further includes computer program code instructions configured to identify, while the drone moves along with the bicyclist, one or more stationary vehicles along a route of the bicyclist. The apparatus of this example embodiment further includes computer program code instructions configured to cause the drone to move further in advance of the bicyclist responsive to identifying one or more stationary vehicles in order to detect the at least one event. In this example embodiment, the computer program code instructions configured to cause the drone to move further in advance of the bicyclist may include computer program code instructions configured to cause the drone to travel alongside the one or more stationary vehicles and to cause a first alert to be provided regarding the one or more stationary vehicles in advance of the bicyclist. The computer program code instructions of this example embodiment may also be configured to detect, while the drone travels alongside the one or more stationary vehicles, a first type of event indicative of a door of the one or more stationary vehicles being subsequently opened and to cause a second alert, different than the first alert, to be provided in response to detection of the first type of event. Additionally, the computer program code instructions of this example embodiment may be configured to detect, while the drone travels alongside the one or more stationary vehicles, a second type of event indicative of the door of the one or more stationary vehicles being opened and to cause a third alert, different than the first and second alerts, to be provided in response to detection of the second type of event. The apparatus of an example embodiment also includes computer program code instructions configured to determine that the bicyclist has passed the vehicle and computer program code instructions, responsive to a determination that the bicyclist has passed the vehicle, configured to cause the drone to discontinue its positioning relative to the vehicle.

In a further example embodiment, a computer program product is provided that includes at least one non-transitory computer-readable storage medium having computer-executable program code instructions stored therein with the computer-executable program code instructions including program code instructions configured to detect at least one event indicative of a part of a vehicle moving into a path of a bicyclist and, responsive to detection of the at least one event, cause an unmanned drone to be positioned relative to the vehicle so as to provide an indication regarding the vehicle moving into the path of the bicyclist. In relation to detecting the at least one event, the vehicle has a speed that is no greater than a predefined threshold.

The computer-executable program code instructions of an example embodiment also include program code instructions configured to determine that the bicyclist is approaching the vehicle and program code instructions configured to determine that the vehicle has a speed that is no greater than the predefined threshold. In this example embodiment, the detection of the at least one event is responsive to determinations that the bicyclist is approaching the vehicle and that the vehicle has a speed that is no greater than the predefined threshold.

In one embodiment, the program code instructions configured to detect the at least one event include program code instructions configured to detect the at least one event indicative of a door of the vehicle being opened. In this regard, the at least one event indicative of the door of the vehicle being opened includes detecting the at least one event selected from the group consisting of: a person being onboard the vehicle, a transmission of the vehicle being in park, an engine of the vehicle being off, the vehicle having come to a halt within a first predefined period of time, a part of the vehicle being indicative of having been recently operated, lettering or signage on the vehicle indicative of the vehicle being a taxi, and a medallion, decal or sign carried by the vehicle indicative of the vehicle providing ride share services. In another embodiment, the program code instructions configured to detect the at least one event include program code instructions configured to detect the at least one event indicative of the vehicle subsequently pulling out into path of the bicyclist. In this regard, the at least one event indicative of the vehicle subsequently pulling out into the path of the bicyclist includes detecting the at least one event selected from the group consisting of: a person being onboard the vehicle, a transmission of the vehicle being in gear, an engine of the vehicle running, brakes of the vehicle having been released, a steering wheel of the vehicle having been moved within a first predefined period of time, a wheel of the vehicle having been moved within the first predefined period of time and a person having entered the vehicle within a second predefined period of time.

The computer-executable program code instructions of an example embodiment also include program code instructions configured to cause the drone to move along with the bicyclist. The computer-executable program code instructions of this example embodiment also include program code instructions configured to identify, while the drone moves along with the bicyclist, one or more stationary vehicles along a route of the bicyclist. The computer-executable program code instructions of this example embodiment also include program code instructions configured to cause the drone to move further in advance of the bicyclist responsive to identifying one or more stationary vehicles in order to detect the at least one event. In this example embodiment, the program code instructions configured to cause the drone to move further in advance of the bicyclist may include program code instructions configured to cause the drone to travel alongside the one or more stationary vehicles and to cause a first alert to be provided regarding the one or more stationary vehicles in advance of the bicyclist. The program code instructions of this example embodiment may also be configured to detect, while the drone travels alongside the one or more stationary vehicles, a first type of event indicative of a door of the one or more stationary vehicles being subsequently opened and to cause a second alert, different than the first alert, to be provided in response to detection of the first type of event. Additionally, the program code instructions of this example embodiment may be configured to detect, while the drone travels alongside the one or more stationary vehicles, a second type of event indicative of the door of the one or more stationary vehicles being opened and to cause a third alert, different than the first and second alerts, to be provided in response to detection of the second type of event. The computer-executable program code instructions of an example embodiment also include program code instructions configured to determine that the bicyclist has passed the vehicle and program code instructions, responsive to a determination that the bicyclist has passed the vehicle, configured to cause the drone to discontinue its positioning relative to the vehicle.

In one embodiment, a method is provided that includes detecting at least one event indicative of a door of a vehicle being opened into the path of a bicyclist or another vehicle. Responsive to detection of the at least one event, the method also includes causing an unmanned drone to take an ameliorative action.

The method of an example embodiment may cause the unmanned drone to take an ameliorative action by causing the drone to be positioned relative to the vehicle so as to provide an indication regarding the door of the vehicle being opened. In this example embodiment, the method may cause the drone to be positioned relative to the vehicle by causing the drone to be positioned proximate the door of the vehicle. Additionally, the method of an example embodiment may cause the unmanned drone to take an ameliorative action by causing the drone to be positioned in the path of the bicyclist or another vehicle so as to provide an indication regarding the door of the vehicle being opened.

The method of an example embodiment also includes determining that the bicyclist or another vehicle is approaching the vehicle. In this embodiment, the detection of at least one event is responsive to determining that the bicyclist or the another vehicle is approaching the vehicle. In this example embodiment, the method also includes determining that the bicyclist or the another vehicle has passed the vehicle and, responsive to a determination that the bicyclist or the another vehicle has passed the vehicle, causing the drone to discontinue the ameliorative action taken by the drone. In an example embodiment, the method detects at least one event indicative of the door of the vehicle being opened by detecting the at least one event selected from the group consisting of: a person being onboard the vehicle, a transmission of the vehicle being in park, an engine of the vehicle being off, the vehicle having come to a halt within a first predefined period of time, a part of the vehicle being indicative of having been recently operated, lettering or signage on the vehicle indicative of the vehicle being a taxi, and a medallion, decal or sign carried by the vehicle indicative of the vehicle providing ride share services.

The method of an example embodiment also includes causing the drone to move along with a bicyclist or another vehicle, identifying, while the drone moves along with the bicyclist or the another vehicle, one or more stationary vehicles along a route of the bicyclist or the another vehicle and, responsive to identifying one or more stationary vehicles, causing the drone to move further in advance of the bicyclist or the another vehicle in order to detect the at least one event. In this example embodiment, the method may cause the drone to move further in advance of the bicyclist or the another vehicle by causing the drone to travel alongside the one or more stationary vehicles and the method may further include causing a first alert to be provided regarding the one or more stationary vehicles in advance of the bicyclist or another vehicle. The method of this example embodiment may also detect, while the drone travels alongside the one or more stationary vehicles, a first type of event indicative of a door of the one or more stationary vehicles being subsequently opened and cause a second alert, different than the first alert, to be provided in response to detection of the first type of event. Additionally, the method of this example embodiment may detect, while the drone travels alongside the one or more stationary vehicles, a second type of event indicative of the door of the one or more stationary vehicles being opened and cause a third alert, different than the first and second alerts, to be provided in response to detection of the second type of event.

In another embodiment, an apparatus is provided that includes at least one processor and at least one non-transitory memory including computer program code instructions stored therein with the computer program code instructions configured to, when executed by the at least one processor, cause the apparatus at least to detect at least one event indicative of a door of a vehicle being opened into the path of a bicyclist or another vehicle. Responsive to detection of the at least one event, the computer program code instructions are also configured to cause an unmanned drone to take an ameliorative action.

The apparatus of an example embodiment may be caused to cause the unmanned drone to take an ameliorative action by causing the drone to be positioned relative to the vehicle so as to provide an indication regarding the door of the vehicle being opened. In this example embodiment, the apparatus may be caused to cause the drone to be positioned relative to the vehicle by causing the drone to be positioned proximate the door of the vehicle. Additionally, the apparatus of an example embodiment may be caused to cause the unmanned drone to take an ameliorative action by causing the drone to be positioned in the path of the bicyclist or another vehicle so as to provide an indication regarding the door of the vehicle being opened.

The computer program code instructions of an example embodiment are also configured to determine that the bicyclist or another vehicle is approaching the vehicle. In this embodiment, the detection of at least one event is responsive to determining that the bicyclist or the another vehicle is approaching the vehicle. In this example embodiment, the computer program code instructions are also configured to determine that the bicyclist or the another vehicle has passed the vehicle and, responsive to a determination that the bicyclist or the another vehicle has passed the vehicle, to cause the drone to discontinue the ameliorative action taken by the drone. In an example embodiment, the computer program code instructions configured to detect at least one event indicative of the door of the vehicle being opened include computer program code instructions configured to detect the at least one event selected from the group consisting of: a person being onboard the vehicle, a transmission of the vehicle being in park, an engine of the vehicle being off, the vehicle having come to a halt within a first predefined period of time, a part of the vehicle being indicative of having been recently operated, lettering or signage on the vehicle indicative of the vehicle being a taxi, and a medallion, decal or sign carried by the vehicle indicative of the vehicle providing ride share services.

The computer program code instructions of an example embodiment are also configured to cause the drone to move along with a bicyclist or another vehicle, to identify, while the drone moves along with the bicyclist or the another vehicle, one or more stationary vehicles along a route of the bicyclist or the another vehicle and, responsive to identifying one or more stationary vehicles, to cause the drone to move further in advance of the bicyclist or the another vehicle in order to detect the at least one event. In this example embodiment, the computer program code instructions may be configured to cause the drone to move further in advance of the bicyclist or the another vehicle by causing the drone to travel alongside the one or more stationary vehicles and the computer program code instructions may be further configured to cause a first alert to be provided regarding the one or more stationary vehicles in advance of the bicyclist or another vehicle. The computer program code instructions of this example embodiment may also be configured to detect, while the drone travels alongside the one or more stationary vehicles, a first type of event indicative of a door of the one or more stationary vehicles being subsequently opened and to cause a second alert, different than the first alert, to be provided in response to detection of the first type of event. Additionally, the computer program code instructions of this example embodiment may be configured to detect, while the drone travels alongside the one or more stationary vehicles, a second type of event indicative of the door of the one or more stationary vehicles being opened and to cause a third alert, different than the first and second alerts, to be provided in response to detection of the second type of event.

In yet another embodiment, a computer program product is provided that includes at least one non-transitory computer-readable storage medium having computer-executable program code instructions stored therein with the computer-executable program code instructions including program code instructions configured to detect at least one event indicative of a door of a vehicle being opened into the path of a bicyclist or another vehicle. Responsive to detection of the at least one event, the computer-executable program code instructions also include program code instructions configured to cause an unmanned drone to take an ameliorative action.

The program code instructions of an example embodiment that are configured to cause the unmanned drone to take an ameliorative action may include program code instructions configured to cause the drone to be positioned relative to the vehicle so as to provide an indication regarding the door of the vehicle being opened. In this example embodiment, the program code instructions configured to cause the drone to be positioned relative to the vehicle may include program code instructions configured to cause the drone to be positioned proximate the door of the vehicle. Additionally, the program code instructions of an example embodiment that are configured to cause the unmanned drone to take an ameliorative action may include program code instructions configured to cause the drone to be positioned in the path of the bicyclist or another vehicle so as to provide an indication regarding the door of the vehicle being opened.

The computer-executable program code instructions of an example embodiment also include program code instructions configured to determine that the bicyclist or another vehicle is approaching the vehicle. In this embodiment, the detection of at least one event is responsive to determining that the bicyclist or the another vehicle is approaching the vehicle. In this example embodiment, the computer-executable program code instructions also include program code instructions configured to determine that the bicyclist or the another vehicle has passed the vehicle and, responsive to a determination that the bicyclist or the another vehicle has passed the vehicle, to cause the drone to discontinue the ameliorative action taken by the drone. In an example embodiment, the program code instructions configured to detect at least one event indicative of the door of the vehicle being opened include program code instructions configured to detect the at least one event selected from the group consisting of: a person being onboard the vehicle, a transmission of the vehicle being in park, an engine of the vehicle being off, the vehicle having come to a halt within a first predefined period of time, a part of the vehicle being indicative of having been recently operated, lettering or signage on the vehicle indicative of the vehicle being a taxi, and a medallion, decal or sign carried by the vehicle indicative of the vehicle providing ride share services.

The computer-executable program code instructions of an example embodiment also include program code instructions configured to cause the drone to move along with a bicyclist or another vehicle, to identify, while the drone moves along with the bicyclist or the another vehicle, one or more stationary vehicles along a route of the bicyclist or the another vehicle and, responsive to identifying one or more stationary vehicles, to cause the drone to move further in advance of the bicyclist or the another vehicle in order to detect the at least one event. In this example embodiment, the program code instructions configured to cause the drone to move further in advance of the bicyclist or the another vehicle may include program code instructions configured to cause the drone to travel alongside the one or more stationary vehicles and the computer-executable program code instructions may further include program code instructions configured to cause a first alert to be provided regarding the one or more stationary vehicles in advance of the bicyclist or another vehicle. The computer-executable program code instructions of an example embodiment may also include program code instructions configured to detect, while the drone travels alongside the one or more stationary vehicles, a first type of event indicative of a door of the one or more stationary vehicles being subsequently opened and program code instructions configured to cause a second alert, different than the first alert, to be provided in response to detection of the first type of event. Additionally, the computer-executable program code instructions of an example embodiment may also include program code instructions configured to detect, while the drone travels alongside the one or more stationary vehicles, a second type of event indicative of the door of the one or more stationary vehicles being opened and program code instructions configured to cause a third alert, different than the first and second alerts, to be provided in response to detection of the second type of event.

In an example embodiment, a method is provided that includes detecting at least one event indicative of a vehicle subsequently pulling, from a stationary position, out into a lane of traffic. Responsive to detection of the at least one event, the method also includes causing an unmanned drone to be positioned relative to the vehicle, such as proximate the door of the vehicle, so as to provide an indication regarding the vehicle subsequently pulling out into the lane of traffic.

The method of an example embodiment also includes determining that a bicyclist or another vehicle is approaching the vehicle and determining that the vehicle is stationary. In this example embodiment, the detection of at least one event is responsive to determinations that the bicyclist or the another vehicle is approaching the vehicle and that the vehicle is stationary. In an example embodiment, the method also includes determining that the bicyclist or the another vehicle has passed the vehicle and, responsive to a determination that the bicyclist or the another vehicle has passed the vehicle, causing the drone to discontinue its positioning relative to the vehicle.

The method of an example embodiment detects at least one event indicative of the vehicle subsequently pulling out into the lane of traffic by detecting the at least one event selected from the group consisting of: a person being onboard the vehicle, a transmission of the vehicle being in gear, an engine of the vehicle running, brakes of the vehicle having been released, a steering wheel of the vehicle having been moved within a first predefined period of time and a wheel of the vehicle having been moved within the first predefined period of time. In an example embodiment, the method also includes causing the drone to move along with a bicyclist or another vehicle, identifying, while the drone moves along with the bicyclist or the another vehicle, one or more stationary vehicles along a route of the bicyclist or the another vehicle and, responsive to identifying one or more stationary vehicles, causing the drone to move further in advance of the bicyclist or the another vehicle in order to detect the one or more events. In this example embodiment, the method may cause the drone to move further in advance of the bicyclist or another vehicle by causing the drone to travel alongside the one or more stationary vehicles and the method may further include causing a first alert to be provided regarding the one or more stationary vehicles in advance of the bicyclist or another vehicle. The method of this example embodiment may also detect the at least one event by detecting the at least one event while the drone travels alongside the one or more stationary vehicles, and the method further include causing a second alert, different than the first alert, to be provided in response to detection of the at least one event.

In another example embodiment, an apparatus is provided that includes at least one processor and at least one non-transitory memory including computer program code instructions stored therein with the computer program code instructions configured to, when executed by the at least one processor, cause the apparatus at least to detect at least one event indicative of a vehicle subsequently pulling, from a stationary position, out into a lane of traffic. Responsive to detection of the at least one event, the computer program code instructions are also configured to cause an unmanned drone to be positioned relative to the vehicle, such as proximate the door of the vehicle, so as to provide an indication regarding the vehicle subsequently pulling out into the lane of traffic.

The computer program code instructions of an example embodiment are also configured to determine that a bicyclist or another vehicle is approaching the vehicle and to determine that the vehicle is stationary. In this example embodiment, the detection of at least one event is responsive to determinations that the bicyclist or the another vehicle is approaching the vehicle and that the vehicle is stationary. In an example embodiment, the computer program code instructions are also configured to determine that the bicyclist or the another vehicle has passed the vehicle and, responsive to a determination that the bicyclist or the another vehicle has passed the vehicle, to cause the drone to discontinue its positioning relative to the vehicle.

The computer program code instructions configured to detect at least one event indicative of the vehicle subsequently pulling out into the lane of traffic include, in one embodiment, computer program code instructions configured to detect the at least one event selected from the group consisting of: a person being onboard the vehicle, a transmission of the vehicle being in gear, an engine of the vehicle running, brakes of the vehicle having been released, a steering wheel of the vehicle having been moved within a first predefined period of time and a wheel of the vehicle having been moved within the first predefined period of time. In an example embodiment, the computer program code instructions are also configured to cause the drone to move along with a bicyclist or another vehicle, identify, while the drone moves along with the bicyclist or the another vehicle, one or more stationary vehicles along a route of the bicyclist or the another vehicle and, responsive to identifying one or more stationary vehicles, cause the drone to move further in advance of the bicyclist or the another vehicle in order to detect the one or more events. In this example embodiment, the computer program code instructions may be configured to cause the drone to move further in advance of the bicyclist or another vehicle by causing the drone to travel alongside the one or more stationary vehicles and the computer program code instructions may also be configured to cause a first alert to be provided regarding the one or more stationary vehicles in advance of the bicyclist or another vehicle. In this example embodiment, the computer program code instructions may also be configured to detect the at least one event by detecting the at least one event while the drone travels alongside the one or more stationary vehicles, and the computer program code instructions may additionally be configured to cause a second alert, different than the first alert, to be provided in response to detection of the at least one event.

In yet another example embodiment, a computer program product is provided that includes at least one non-transitory computer-readable storage medium having computer-executable program code instructions stored therein with the computer-executable program code instructions including program code instructions configured to detect at least one event indicative of a vehicle subsequently pulling, from a stationary position, out into a lane of traffic. Responsive to detection of the at least one event, the computer-executable program code instructions also include program code instructions configured to cause an unmanned drone to be positioned relative to the vehicle, such as proximate the door of the vehicle, so as to provide an indication regarding the vehicle subsequently pulling out into the lane of traffic.

The computer-executable program code instructions of an example embodiment also include program code instructions configured to determine that a bicyclist or another vehicle is approaching the vehicle and to determine that the vehicle is stationary. In this example embodiment, the detection of at least one event is responsive to determinations that the bicyclist or the another vehicle is approaching the vehicle and that the vehicle is stationary. In an example embodiment, the computer-executable program code instructions also include program code instructions configured to determine that the bicyclist or the another vehicle has passed the vehicle and, responsive to a determination that the bicyclist or the another vehicle has passed the vehicle, to cause the drone to discontinue its positioning relative to the vehicle.

The program code instructions configured to detect at least one event indicative of the vehicle subsequently pulling out into the lane of traffic include, in one embodiment, program code instructions configured to detect the at least one event selected from the group consisting of: a person being onboard the vehicle, a transmission of the vehicle being in gear, an engine of the vehicle running, brakes of the vehicle having been released, a steering wheel of the vehicle having been moved within a first predefined period of time and a wheel of the vehicle having been moved within the first predefined period of time. In an example embodiment, the computer-executable program code instructions also include program code instructions configured to cause the drone to move along with a bicyclist or another vehicle, identify, while the drone moves along with the bicyclist or the another vehicle, one or more stationary vehicles along a route of the bicyclist or the another vehicle and, responsive to identifying one or more stationary vehicles, cause the drone to move further in advance of the bicyclist or the another vehicle in order to detect the one or more events. In this example embodiment, the program code instructions may be configured to cause the drone to move further in advance of the bicyclist or another vehicle by causing the drone to travel alongside the one or more stationary vehicles and the computer-executable program code instructions may also be configured to cause a first alert to be provided regarding the one or more stationary vehicles in advance of the bicyclist or another vehicle. In this example embodiment, the program code instructions may also be configured to detect the at least one event by detecting the at least one event while the drone travels alongside the one or more stationary vehicles, and the computer-executable program code instructions may additionally be configured to cause a second alert, different than the first alert, to be provided in response to detection of the at least one event.

### BRIEF DESCRIPTION OF THE SEVERAL VIEWS OF THE DRAWINGS

Having thus described certain embodiments of the invention in general terms, reference will now be made to the accompanying drawings, which are not necessarily drawn to scale, and wherein:

FIG. 1 is a perspective view of a vehicle that is parked alongside a road and a bicyclist approaching the parked vehicle in an adjacent lane of travel;

FIG. 2 is a block diagram of an apparatus that may be specifically configured in accordance with an example embodiment of the present disclosure;

FIG. 3 is a flowchart illustrating operations performed, such as by the apparatus of FIG. 2, in order to detect at least one event indicative of a part of vehicle moving into the path of a bicyclist or another vehicle and to cause a UAV to be positioned relative to the vehicle in response to the detection of the at least one event in accordance with an example embodiment of the present disclosure;

FIGS. 4A and 4B are a perspective view and an end view, respectively, of a parked vehicle for at which at least one event has been detected and the UAV has been positioned relative to the parked vehicle in order to provide an indication to an approaching bicyclist or another vehicle in accordance with an example embodiment of the present disclosure;

FIG. 5 is a flow chart illustrating operations performed, such as by the apparatus of FIG. 2, in accordance with an example embodiment in which a UAV flies along with a bicyclist or another vehicle and then flies in advance of the bicyclist or the other vehicle upon the detection of one or more stationary vehicles along the route of the bicyclist or the other vehicle in order to detect at least one event associated with the stationary vehicle that is indicative of a part of the vehicle moving into the path of travel of the bicyclist or the other vehicle;

FIG. 6 is a flow chart illustrating operations performed, such as by the apparatus of FIG. 2, in order to detect at least one event indicative of a door of a vehicle being subsequently opened and then to cause a UAV to be positioned relative to the vehicle to provide an indication of the subsequent opening of the door in accordance with another example embodiment of the present disclosure; and

FIG. 7 is a flow chart illustrating operations performed, such as by the apparatus of FIG. 2, in order to detect at least one event indicative of a vehicle subsequently pulling from a parking space out into lane of travel and to cause a UAV to be positioned relative to the vehicle to provide an indication regarding the vehicle subsequently pulling out from the parking space into a lane of travel in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

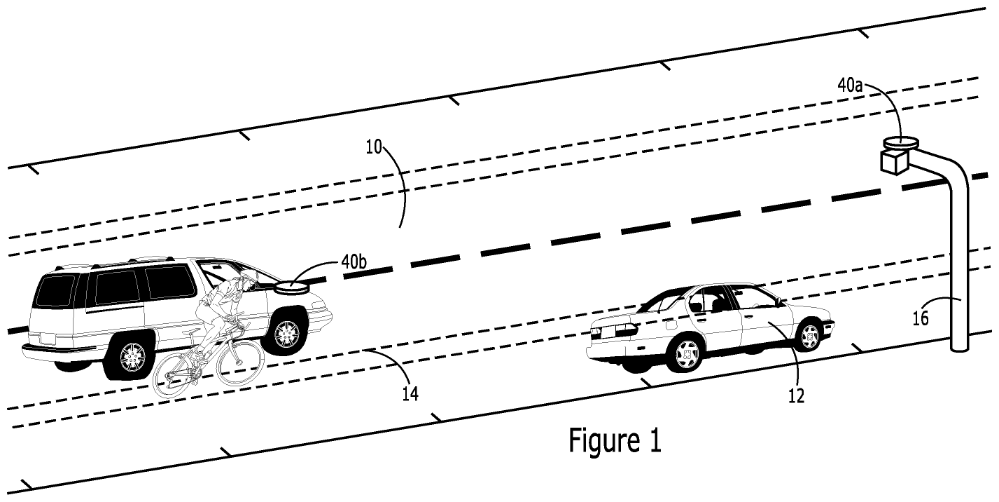

Parked vehicles create a variety of obstacles for bicyclist and other vehicles that travel along a lane of a road adjacent the parked vehicle. As shown in FIG. 1, for example, a road 10 may include two lanes of traffic to support travel in two opposed directions. The road may also include parking spots along the side of the road for vehicles. Parking spaces may be marked as shown in FIG. 1 or unmarked. Vehicles may park in the parking spaces in various relative positions with respect to the lanes of travel defined by the road. As shown in FIG. 1, a vehicle 12 may park adjacent the lane of travel such that the parked vehicle remains parallel to the lane of travel and oriented in the same direction in which a bicyclist or other vehicles are traveling. Alternatively, angled parking spaces may be defined adjacent a lane of travel of a road. In this instance, vehicles are parked at an angle, such as 45 degrees, relative to the path of travel defined by a lane of the road.

In the illustrated embodiment, the road 10 not only defines two opposed lanes of travel for vehicular traffic, but the road defines a bicycle lane 14 between the lane of travel for vehicular traffic and the parking spaces. The bicycle lane of this example embodiment is immediately adjacent the parking spaces, while the lane of travel for vehicular traffic is separated from the parking spaces by the bicycle lane. In other embodiments, however, the road does not define a bicycle lane and, instead, bicyclists ride in the same lane as other vehicular traffic such that both bicyclist and the other vehicular traffic are immediately adjacent the parking spaces defined by the road.

In order to reduce the risks associated with unexpected movement of a part of a vehicle 12 that has been parked alongside a road 10 into the path of travel of a bicyclist or other vehicle, such as the risk occasioned by dooring in which the door of a parked vehicle is unexpectedly opened into the path of travel or a vehicle that was previously parked pulling out from a parking space into the path of travel, a method, apparatus and computer program product are provided in accordance with an example embodiment in order to detect at least one event indicative of a part of the vehicle moving into the path of travel of a bicyclist or other vehicle and, in response, causing an unmanned drone, such as an unmanned air vehicle (UAV) or other controllable flying object or a ground-based unmanned vehicle, to take some ameliorative action regarding the part of the vehicle moving into the path of travel of the bicyclist or other vehicle, such as by providing an indication of the part of the vehicle moving into the path of travel of the bicyclist or other vehicle.

The apparatus of this example embodiment may be embodied by any of a variety of computing devices, such as a computer, a mobile terminal, such as a personal digital assistant (PDA), mobile telephone, smart phone, personal navigation device, wearable device, smart watch, tablet computer and/or other device that can perform navigation-related functions, such as digital routing and map display, or a fixed computing device, such as a computer workstation, a navigation system or the like.

The computing device of an example embodiment is embodied and carried by the drone. Alternatively, the computing device may be onboard a vehicle, such as the parked vehicle or another vehicle. In this embodiment, the computing device may be embodied, for example, by a navigation system of the vehicle. Still further, the computing device may be embodied by a mobile device carried by a bicyclist or by an occupant of one or more of the vehicles, such as a mobile terminal. In yet other embodiments, the computing device is a fixed computing device associated with a geographical region, e.g., a city block, such as a computing device embodied by a smart street lamp or the like. The computing device of some embodiments is distributed and includes a plurality of computing devices, such as one or more of the computing devices described above, that cooperate in order to perform the functions described below.

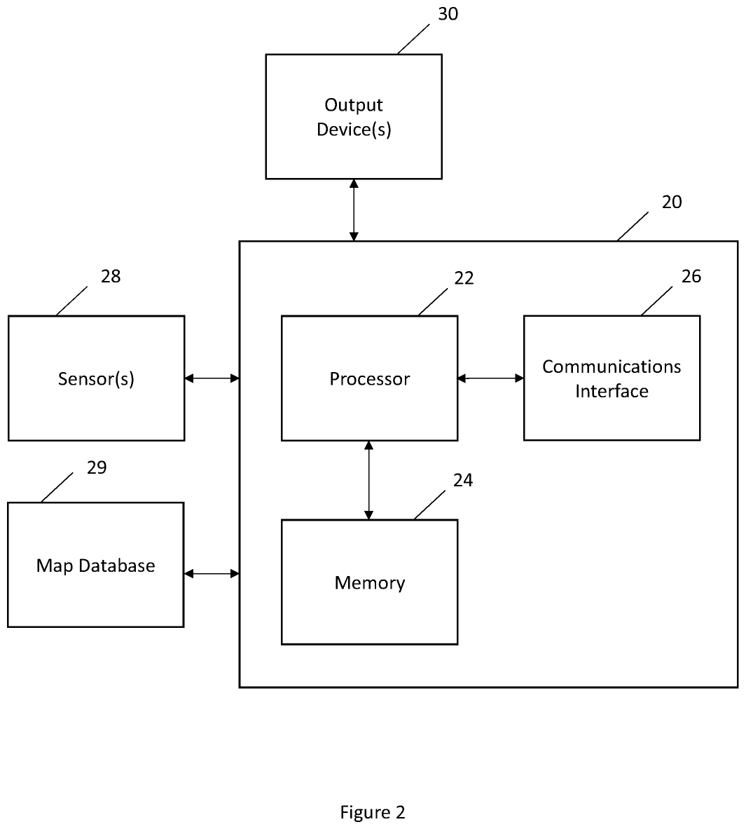

As illustrated in FIG. 2, the apparatus 20 of an example embodiment includes, is associated with or is otherwise in communication with a processor 22, a memory device 24 and optionally a communication interface 26. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also optionally include a communication interface 26 that may be any means such as a device or circuitry embodied in either hardware or a combination of hardware and software that is configured to receive and/or transmit data from/to other electronic devices in communication with the apparatus. Additionally or alternatively, the communication interface may be configured to communicate in accordance with various wireless protocols including Global System for Mobile Communications (GSM), such as but not limited to Long Term Evolution (LTE). In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s).

The apparatus 20 of an example embodiment may also include one or more sensors 28 and/or one or more output devices 30. However, the sensor(s) and the output device(s) of the embodiment depicted in FIG. 2 are separate from the apparatus, but in communication with the apparatus, such as via the communication interface 26.

The apparatus 20 of an example embodiment may also optionally include or be in communication with a map database 29 that represents road segments in a geographic area that may be utilized, for example, by a drone in order to facilitate its movements. In this regard, the map database contains map data that indicates attributes of the road segments. The map database may also include map data indicative of sidewalks or other types of pedestrian segments, as well as open areas, such as grassy regions or plazas.

The map database 29 may include node data, road segment data or link data, point of interest (POI) data, traffic data or the like. The map database may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database may contain path segment and node data records or other data that may represent bicycle lanes, pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database can include data about the POIs and their respective locations in the POI records. The map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database.

The map database 29 may be a master map database, such as a high definition (HD) map database, stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation.

As mentioned above, the map database 29 may be a master geographic database, but in alternate or complementary embodiments, a client side map database may represent a compiled navigation database that may be used in or with a drone to provide navigation and/or map-related functions. In such a case, the map database can be downloaded or stored on the drone which can access the map database through a wireless or wired connection, such as a communications network.

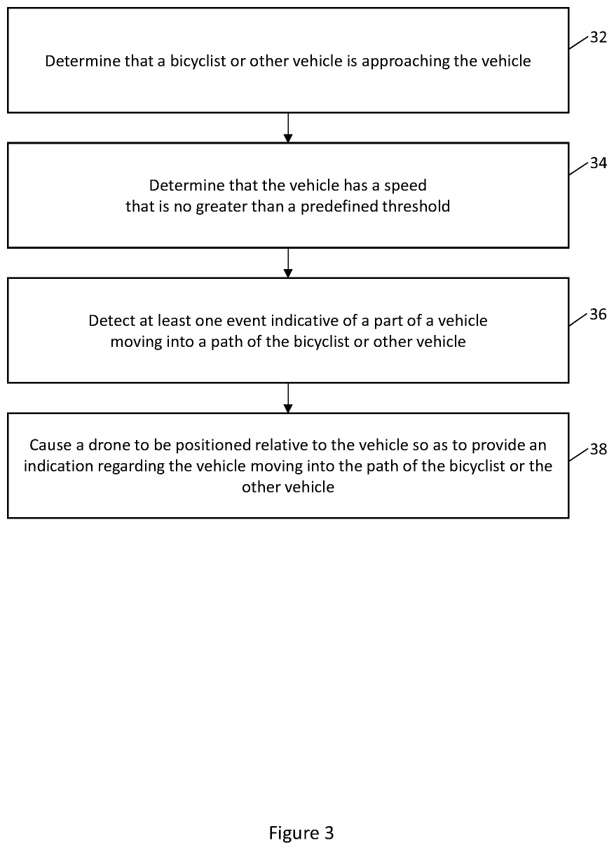

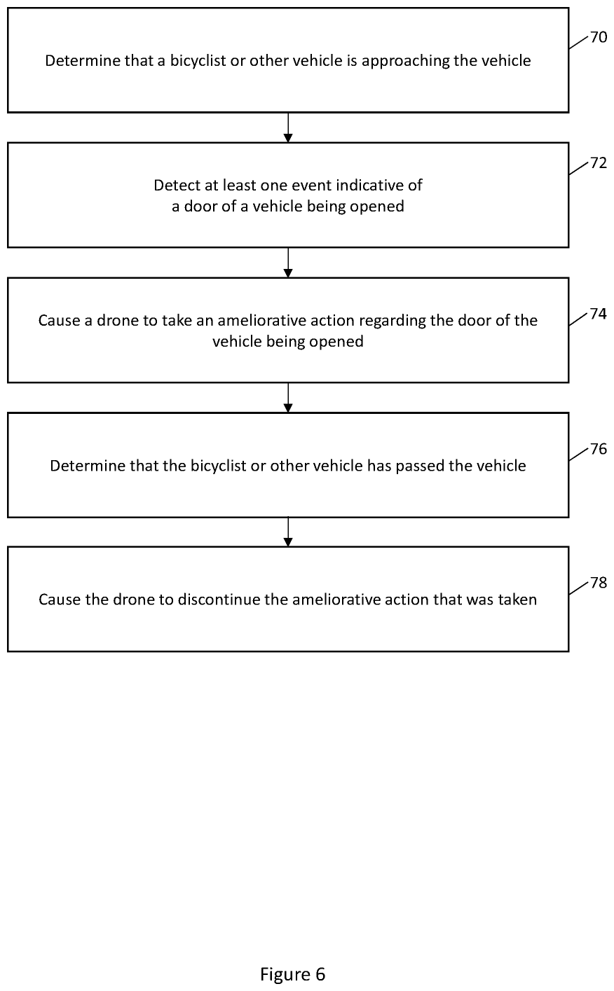

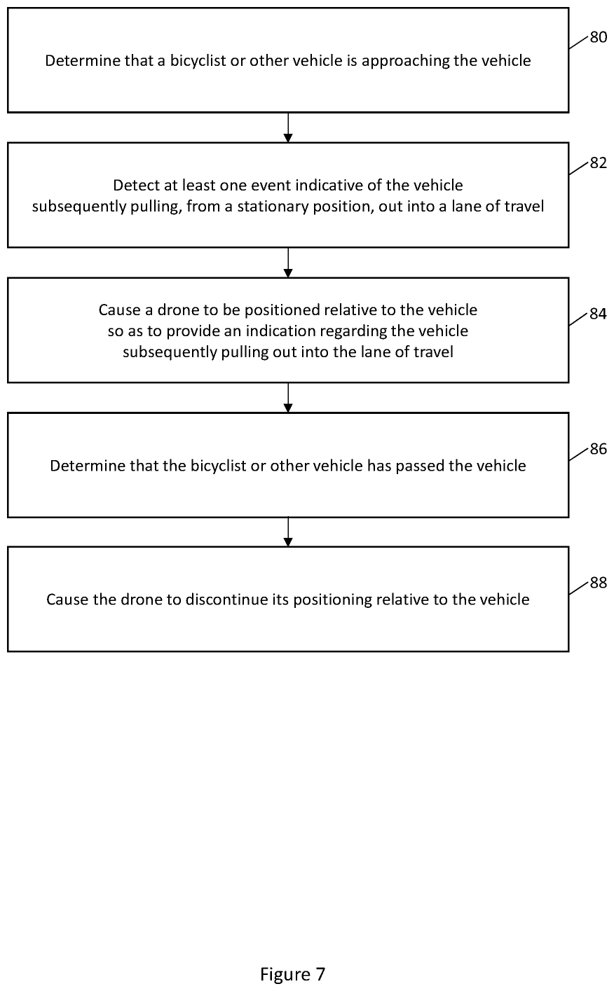

Referring now to FIG. 3, the operations performed, such as by the apparatus 20 of FIG. 2, in accordance with an example embodiment are depicted. As shown in block 36 of FIG. 3, the apparatus includes means, such as the processor 22, at least one sensor 28 or the like, for detecting at least one event indicative of a part of a vehicle moving into the path of travel of a bicyclist or other vehicle, such as an automobile, a truck or the like. As described below in relation to the embodiments of FIGS. 6 and 7, a variety of events and, in some embodiments, a variety of sequences of events, may be detected and identified to be indicative of a part of a vehicle moving into the path of travel of a bicyclist or other vehicle. In some embodiment, the apparatus includes the one or more sensors for detecting the events. In other embodiments, however, the sensors or at least some of the sensors are separate from the apparatus, but the apparatus, such as the communication interface 26, is configured to be in communication with the sensors or to otherwise receive information based upon the observations of the sensor(s). In this embodiment in which the apparatus and the sensors are separate, the apparatus, such as the processor, is configured to detect at least one event based upon an evaluation of the information received by the processor, via the communication interface, relating to the observations of the sensor(s).

For example, the vehicle 12 that is moving into the path of travel of a bicyclist or other vehicle may include one or more sensors 28 for detecting respective events indicative of the part of the vehicle moving into the path of travel. In this example embodiment, the one or more sensors onboard the vehicle may communicate, directly or indirectly, with the apparatus 20, such as via communication interface 26, in order to provide information that is at least based upon observations of the sensors. Additionally or alternatively, the drone and/or a bicycle or other vehicle that is approaching the vehicle that is moving into the path of travel include one or more sensors. Still further, one or more sensors may be fixed in position and associated with a geographic region, e.g., a city block. In this example embodiment, a smart street lamp 16, a traffic control device, e.g., traffic lights or other structure along the road may include the sensor(s). In any of the foregoing embodiments, the sensors may communicate, directly or indirectly, with the apparatus, such as via communication interface, in order to provide information that is at least based upon observations of the sensors.

The vehicle 12 that is being observed in order to determine whether a part of the vehicle is moving into a path of travel of a bicyclist or other vehicle has a speed that is no greater than a predefined threshold. For example, the vehicle may be parked and, as a result, have a speed of zero. Alternatively, the vehicle may have a relatively low speed, such as less than 10 miles per hour or less than 5 miles per hour, such as in an instance in which a vehicle has slowed and is attempting to park in a parking space or in an instance in which a vehicle that has been previously parked begins to slowly move out of the parking space. As such, the vehicle for which at least one event is detected that may be indicative of a part of the vehicle moving into the path of travel has a speed that is no greater than the predefined threshold, such as 10 miles per hour or, in one embodiment, 5 miles per hour.

The at least one event that is detected may be indicative of various parts of the vehicle moving into the path of travel of a bicyclist or other vehicle. For example, the at least one event that is detected may be indicative of a door of the vehicle being opened into the path of travel, such as described below in conjunction with the embodiment of FIG. 6. Alternatively, the at least one event that is detected may be indicative of the vehicle pulling out from the parking space, such that a portion of the body of the vehicle moves into the path of travel, such as described below in conjunction with the embodiment of FIG. 7.

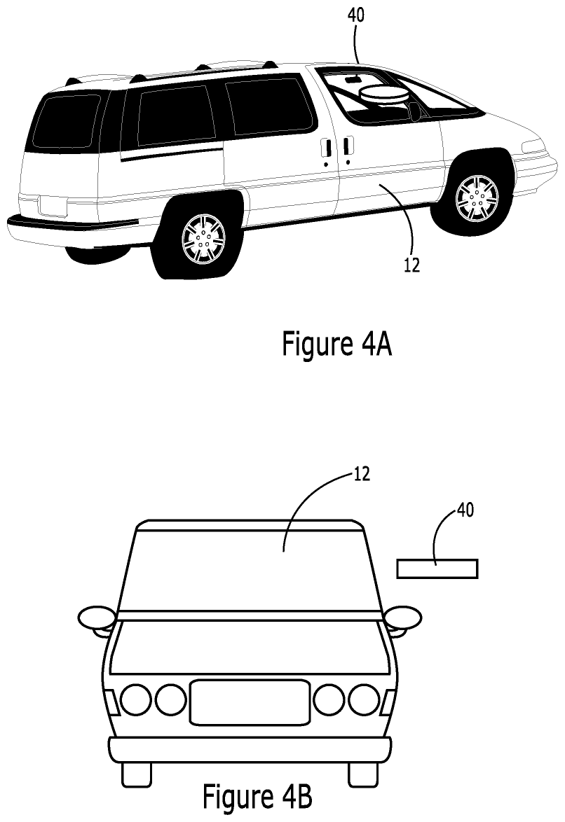

As show in block 38 of FIG. 3, in response to the detection of the at least one event, the apparatus 20 includes means, such as the processor 22 or the like, for causing a drone to be positioned relative to the vehicle so as to provide an indication regarding the vehicle moving into the path of travel of a bicyclist or another vehicle. While the drone may be positioned in various manners to as to provide an indication regarding moving of the vehicle into the path of travel, FIGS. 4A and 4B depict an embodiment to which the drone 40 is caused to be positioned proximate the vehicle 12 and, in the illustrated embodiment, proximate the door of the vehicle. The positioning of the drone proximate the vehicle, such as proximate the door of the vehicle, provides an indication to an oncoming bicyclist or other vehicle as to the possibility of at least part of the vehicle moving into the path of travel of the bicyclist or the other vehicle. As such, the bicyclist or the other vehicle may be forewarned and may take ameliorative action so as to reduce the risk of a traffic accident. For example, the bicyclist or the other vehicle may slow in advance of the parked vehicle. Additionally or alternatively, the bicyclist or the other vehicle may shift over in the lane of travel so as to move further away from the vehicle, thereby increasing the distance between the bicyclist or the other vehicle and the parked vehicle. Additionally or alternatively, the bicyclist or the other vehicle may take into account other traffic on the road so as to have determined in advance the route to be taking if the vehicle that was previously parked should proceed to move into the path of travel.

Not only does the positioning of the drone 40 provide an indication to an oncoming bicyclist or the other vehicle, but the positioning of the drone may also provide an indication to the parked vehicle 12, such as an occupant of the parked vehicle, of an oncoming bicyclist or other vehicle. As such, the vehicle, such as an occupant of the vehicle, may again review their surroundings and identify the oncoming bicyclist or the other vehicle prior to moving into the path of travel. In some embodiments in which the movement of the vehicle into the path of travel includes the opening of a door of the vehicle into the path of travel, the drone may be caused to be position proximate the door so as to affectively block or otherwise prevent the door from being opened or at least to increase the resistance to the opening of the door, thereby further decreasing the risk associated with a collision between the oncoming bicyclist or other vehicle and the door of the vehicle.

Any of a wide variety of drones 40, such as UAVs or other types of controllable flying objects or unmanned ground-based vehicles, may be utilized to provide an indication to an oncoming bicyclist or another vehicle. The drone of FIGS. 4A and 4B is depicted to have a generally cylindrical shape. However, the drone may have any of a variety of different shapes and sizes. The drone is, however, advantageously configured so as to be readily visible by the bicyclist or the driver of the other vehicle and, in one example embodiment, includes visible indicia, such as bright coloring and/or one or more reflectors, in order to increase the likelihood that a driver of an approaching vehicle will see the drone.

In order to increase the likelihood that an oncoming bicyclist or other vehicle will notice the drone 40 positioned proximate a vehicle 12, the drone can include one or more output devices 30. For example, the output devices of the drone may include one or more light sources, such as one or more lights, for emitting visible signals. In some embodiments, the light sources of a drone may be controlled so as to flash or otherwise be illuminated in a pattern or sequence so as to further increase the likelihood that a bicyclist or the driver of the approaching vehicle will see the drone positioned relative to the parked vehicle. The output devices of a drone of an example embodiment may also or alternatively include one or more audible sources, such as a horn, for emitting audible sounds in order to further increase the likelihood that the driver of an approaching vehicle will take note of the drone. The audible source may be controlled so as to cause the audible sounds to be emitted in a pattern or sequence in order to further increase the likelihood that a bicyclist or the driver of an approaching vehicle will hear and, in turn, see the drone hovering relative to the parked vehicle.

In an embodiment in which both the apparatus 20 is embodied by the computing device of the drone 40, the apparatus may also include or be in direct communication with the output device(s) 30 onboard the drone. In other embodiments, however, in which the apparatus is separate from the drone, the apparatus, such as the communication interface 26, is in communication with the drone including the output device(s). As such, the apparatus of this example embodiment also includes means, such as the processor, the communication interface or the like, for causing the output device(s) of the drone to provide output while the drone is positioned proximate the vehicle 12 indicating that the vehicle may move into the path of the oncoming bicyclist or the other vehicle.

Prior to detecting at least one event and as also shown in blocks 32 and 34 of FIG. 3, the apparatus 20 of an example embodiment may also include means, such as the processor 22, the sensor(s) 28 or the like, for determining that a bicyclist or the other vehicle is approaching the parked vehicle 12 and means, such as the processor, the sensor(s) or the like, for determining that the vehicle has a speed that is no greater than the predefined threshold. For example, the apparatus, such as the processor, may be in communication with a sensor, such as an image sensor, e.g., a camera, a proximity sensor, a radar sensor, an infrared sensor, a light detection and ranging (LIDAR) sensor or the like, for determining that a bicyclist or another vehicle is approaching the parked vehicle. Further, the apparatus, such as the processor, may be in communication with a sensor, such as a speed sensor, onboard the vehicle and may monitor the speed of the vehicle. In this example embodiment, the apparatus, such as the processor, is configured to detect the at least one event in response to, that is, contingent upon the determination that a bicyclist or another vehicle is approaching the vehicle and also in response to the determination that the vehicle has a speed that is no greater than the predefined threshold.

The drone 40 that is positioned relative to the vehicle 12 may have a variety of initial positions from which the drone flies so as to be proximate the parked vehicle. For example, the drone may be associated with a particular geographical region, such as a single block or predefined number of continuous blocks of a city street. In this example embodiment, the drone may have an initial position, such as a recharging station that maintains the battery power of the drone. For purposes of illustration, FIG. 1 depicts a drone 40a perched on a street light 16. The street light of this example may be configured to recharge the drone and, as a result, serves as a recharging station for the drone. From its perch on the streetlight, the drone may be caused to be positioned relative to a vehicle parked along the road in order to provide indication to an oncoming bicyclist or other vehicle that a part of the vehicle may move into the path of travel of the bicyclist or other vehicle.

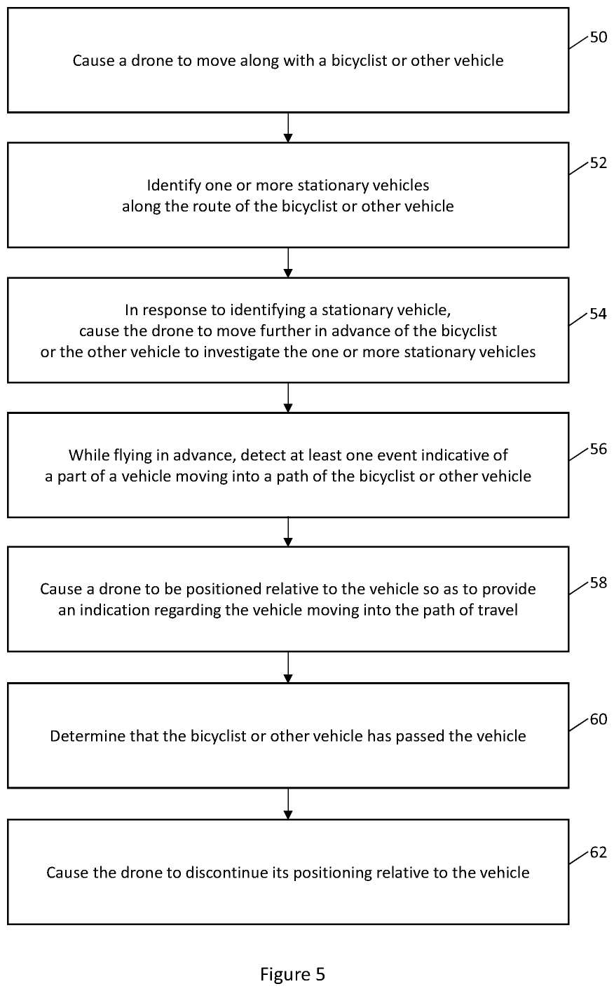

Alternatively, the drone 40 may be associated, not with a geographical region, but with a bicyclist or other vehicle that is traveling along the road 10. In this regard, FIG. 1 also depicts a drone 40b that flies along with the bicyclist. Reference is now made to FIG. 5 in which the operations performed, such as by the apparatus 20 of FIG. 2, are illustrated. In this example embodiment, the apparatus 20 includes means, such as the processor 22 or the like, for causing the drone to move along with the bicyclist or other vehicle. See block 50 of FIG. 5. As an alternative to flying along with a bicyclist or other vehicle as shown in FIG. 1, the drone of another embodiment may move along with the bicyclist or other vehicle by being carried by the bicycle or the other vehicle. In an embodiment in which the drone moves along with another vehicle, for example, the drone may not only be carried by the other vehicle, such as by resting upon the roof, trunk, truck bed or the like of the other vehicle, but the drone may be tethered to the electrical system of the other vehicle while the drone is being carried thereby so as to provide for recharging of the UAV.

While the drone moves along with the bicyclist or other vehicle, the apparatus 20 includes means, such as the processor 22, one or more sensors 28 or the like, for identifying one or more stationary vehicles along the route and in advance of the bicyclist or other vehicle. See block 52. In this regard, the route of the bicyclist or other vehicle may be predefined, such as with reference to the map database 29 in an instance in which the bicyclist or the driver of the vehicle has identified a specific series of road segments leading from a starting point (also referred to as an origin) to an end point (also referred to as a destination). For example, an individual may use an application (app) to get a “route” (a series of connected road segments) from a current position (i.e., an “origin”) to an inputted address (i.e., a “destination”). Alternatively, in the absence of a predefined route, the route of the bicyclist or the other vehicle may be defined as a predefined length of the road in advance of the bicyclist or other vehicle in the direction in which the bicyclist or other vehicle is currently traveling.

The apparatus 20, such as the processor 22, is configured to identify one or more stationary vehicles located along the route and within a predefined distance of the bicyclist or other vehicle, such as within one or two blocks in advance of the bicyclist or other vehicle. The stationary vehicles may be identified in various manners. For example, the apparatus may include or be in communication with a sensor, such as an image sensor, a radar sensor, an infrared sensor, a LIDAR sensor or the like, for capturing a plurality of images over time of the road in advance of the bicyclist or the other vehicle. The apparatus, such as the processor, of this example embodiment is configured to analyze the plurality of images and to identify therefrom one or more stationary vehicles located along the route.

In response to identifying one or more stationary vehicles and as shown in block 54 of FIG. 5, the apparatus 20 of this example embodiment also includes means, such as the processor 22 or the like, for causing the drone to move, e.g., fly, further in advance of the bicyclist or other vehicle in order to investigate the one or more stationary vehicles and to detect the at least one event as described above in conjunction with block 34 of FIG. 3. In this regard, the identification of one or more stationary vehicles along the route of the bicyclist or other vehicle causes the drone to move, e.g., fly, ahead of the bicyclist, and, in embodiments in which the drone includes one or more sensors 28, to detect the at least one event indicative of a part of the vehicle moving into the path of travel of the bicyclist or other vehicle. As described above in conjunction with blocks 34 and 36 of FIG. 3 and as now shown in blocks 56 and 58 of FIG. 5, the apparatus of this example embodiment also includes means, such as the processor, at least one sensor or the like, for detecting at least one event indicative of a part of the vehicle moving into the path of travel of the bicyclist or other vehicle and means, responsive to detection of the at least one event, such as the processor or the like, for causing the drone to provide an indication regarding the vehicle moving into the path of the bicyclist or other vehicle, such as by providing the indication based upon the positioning of the drone relative to the vehicle.

In an example embodiment, the apparatus 20 includes means, such as the processor 22 or the like, for causing the drone to move further in advance of the bicyclist or other vehicle by causing the drone to travel alongside the one or more stationary vehicles. While the drone is traveling alongside the one or more stationary vehicles in advance of the bicyclist or other vehicle, the apparatus may include means, such as the processor, an output device 30 or the like, for causing a first alert to be provided regarding the presence of the one or more stationary vehicles in advance of the bicyclist or other vehicle. The first alert may be a cautionary-type of alert, such as by illumination of a yellow light carried by the drone and/or generation of an audible alert, e.g., an audible alert that repeatedly announces “caution”.

The apparatus 20 of this example embodiment may also include means, such as the processor 22, one or more sensors 28 or the like, for detecting, while the drone travels alongside the one or more stationary vehicles, an event, such as a first type of event indicative of a possibility of a part of a stationary vehicle subsequently moving into the path of travel of the bicyclist or the other vehicle, such as a possibility that the door of the stationary vehicle will be subsequently opened into the path of travel of the bicyclist or the other vehicle or a possibility that the stationary vehicle will subsequently pull into the path of travel of the bicyclist or the other vehicle. For example, the processor may be configured to detect the first type of event indicative of a possibility of a part of a stationary vehicle subsequently moving into the path of travel of the bicyclist or the other vehicle in an instance in which an image sensor detects that an occupant is in one of the stationary vehicles and/or in an instance in which an infrared or other heat sensor detects that a part of the stationary vehicle was recently operated and, as a result, is hot, such as in an instance in which the hood, exhaust pipe and/or tires of the stationary vehicle has a temperature greater than a predefined threshold. The apparatus of this example embodiment also includes means, such as the processor, an output device 30 or the like, for causing a second alert, different than the first alert, to be provided in response to detection of the first type of event. For example, in response to the detection of a possibility of a part of a stationary vehicle subsequently moving into the path of travel of the bicyclist or the other vehicle, a second alert, such as in the form of a warning-type of alert may be provided, such as by illumination of a red light carried by the drone and/or generation of an audible alert, e.g., an audible alert that repeatedly announces “warning”.

The apparatus 20 of this example embodiment may further include means, such as the processor 22, one or more sensors 28 or the like, for detecting, while the drone travels alongside the one or more stationary vehicles, a second type of event indicative of a part of the vehicle that was previously stationary actually beginning to move into the path of travel of the bicyclist or the other vehicle, such as by the door of the stationary vehicle being opened, even a small amount, into the path of travel of the bicyclist or the other vehicle or the vehicle that was previously stationary beginning to pull into the path of travel of the bicyclist or the other vehicle. The apparatus of this example embodiment also includes means, such as the processor, an output device 30 or the like, for causing a third alert, different than the first and second alerts, to be provided in response to detection of the second type of event. For example, in response to the detection of a part of a vehicle that was previously stationary actually beginning to move into the path of travel of the bicyclist or the other vehicle, a third alert, such as in the form of a more severe warning-type of alert may be provided, such as by illumination of a flashing red light carried by the drone and the concurrent generation of an audible alert, e.g., an audible alert that repeatedly announces “take evasive action”. Thus, the apparatus of this example embodiment can provide increasingly more severe alerts to a bicyclist or other vehicle that is approaching one or more stationary vehicles to permit the bicyclist or other vehicle to be informed and to permit action to be taken so as to reduce the risk of an accident.

As shown in block 60 of FIG. 5, the apparatus 20 of an example embodiment also includes means, such as the processor 22, at least one sensor 28 or the like, for determining that the bicyclist or other vehicle has passed the parked vehicle 12. In order to determine that the bicyclist or other vehicle has passed the parked vehicle, one or more sensors, such as an image sensor, a proximity sensor, a radar sensor, an infrared sensor, a LIDAR sensor or the like, may capture observations that may, in turn, be analyzed by the processor in order to determine that the bicyclist or other vehicle has passed the parked vehicle.

In response to determining that the bicyclist or other vehicle has passed the parked vehicle 12, the apparatus 20 also includes means, such as the processor 22 or the like, for causing the drone 40 to discontinue its positioning relative to the vehicle. See block 62. In this regard, the drone is caused to be repositioned so as to no longer be positioned relative to the vehicle, such as proximate the vehicle, and, instead, the drone can return to its initial position. In an embodiment in which the drone is associated with a predefined geographic region, the drone may be caused to return to a recharging station, such as by perching upon a street lamp 16 in order for the batteries of the drone to be recharged. Alternatively, in an embodiment as described above in which the drone moves along with a bicyclist or other vehicle, the drone may be repositioned once the bicyclist or other vehicle has passed the parked vehicle so as to catch up to the bicyclist or the other vehicle and to again fly along with the bicyclist or other vehicle or to land upon and be carried by the bicycle or other vehicle, at least until another stationary vehicle along the route of and in advance of the bicyclist or other vehicle is identified. In response to determining that the bicyclist or other vehicle has passed the parked vehicle, the apparatus of some embodiments may include means, such as the processor, an output device 30 or the like, for providing an indication to the parked vehicle or an occupant of the parked vehicle that the bicyclist or other vehicle has passed the parked vehicle, such as by causing a green light carried by the drone to be illuminated or causing an audible signal, e.g., “all clear” to be generated. Similarly, in an instance in which the bicyclist or other vehicle stopped or turned off of the road prior to passing the parked vehicle, the apparatus of some embodiments may also include means, such as the processor, an output device or the like, for providing an indication to the parked vehicle or an occupant of the parked vehicle that the bicyclist or other vehicle is no longer approaching the parked vehicle, such as by causing a green light carried by the drone to be illuminated or causing an audible signal, e.g., “all clear” to be generated.

As indicated above, various parts of a vehicle 12 may move into the path of travel of a bicyclist or other vehicle. For example, FIG. 6 depicts the operations performed, such as by the apparatus 20 of FIG. 2, in order to detect and to respond to at least one event indicative of a door of a vehicle being opened. In this embodiment, the apparatus includes means, such as the processor 22, at least one sensor 28 or the like, for detecting at least one event indicative of a door of a vehicle being opened. See block 72 of FIG. 6. In this regard, the at least one event may occur with the actual opening of the door, such as the partial opening of the door that precedes the full opening of the door, and/or may occur prior to the actual opening of the door so as to serve to predict the subsequent opening of the door. A variety of events may be detected that are indicative, either individually or upon occurrence in a predefined sequence, of the door of a vehicle being opened.

For example, the event may be the detection of a person onboard the vehicle, such as a driver or a passenger, who may open the door of the vehicle. In order to detect the person onboard the vehicle, the sensor 28 may include an image sensor for capturing images of the vehicle and its interior with the apparatus 20, such as the processor 22, being configured to analyze the images to detect the person onboard the vehicle. Other events that may be indicative of the door of a vehicle being opened include the transmission of the vehicle being in park and/or the engine of the vehicle being off. In order to detect the state of the transmission and the engine, one or more sensors, such as one or more sensors onboard the vehicle, may be configured to monitor the transmission and/or the engine. An additional event that may be indicative of the door of the vehicle being opened includes the vehicle having come to a halt within the first predefined period of time. In this regard, the first predetermined period of time is a period of time immediately prior to the current time and is based upon the premise that a vehicle that has recently parked, such as by being parked within the first predetermined period of time, is more likely to have an occupant open the door of the vehicle, such as to exit the vehicle, than a vehicle that has been parked for a longer period of time, such as by having been parked for greater than the first predetermined period of time. Various sensors may be utilized to determine the timing with which a vehicle comes to a halt including one or more sensors onboard the vehicle to detect motion of the vehicle and/or image sensors for capturing images of the vehicle over time that may then be analyzed by the apparatus, such as the processor, to determine the time at which the vehicle came to a halt.

Another example of an event that may be indicative of the door of the vehicle being opened is a determination that a part of the vehicle was recently operated. For example, an infrared or other heat sensor may be configured detect that a part of the vehicle was recently operated and, as a result, is hot, such as in an instance in which the hood, exhaust pipe or tires of the vehicle has a temperature greater than a predefined threshold. Other examples of events that may be indicative of the door of the vehicle being opened may be unique to instances in which the vehicle is a taxi or instances in which the vehicle provides ride share services. For example, lettering or signage on the vehicle that is indicative of the vehicle being a taxi, such as detected by an image sensor, may also be an event indicative of the door of the vehicle being opened, since the door of a taxi may open even though the taxi continues to idle. As another example, a medallion, decal or sign carried by the vehicle that is indicative of the vehicle providing ride share services may also be an event indicative of the door of the vehicle being opened, since the door of a vehicle providing ride share services may open even though the vehicle continues to idle.

While any one or more of these events may be indicative of the door of the vehicle being subsequently opened, the apparatus 20, such as the processor 22, of some embodiments may require a sequence of two or more events to occur, such as in a predefined order, in order to determine that the door of a vehicle is likely to be subsequently opened. For example, a sequence of events indicative of the door of the vehicle being subsequently opened may include the vehicle having come to a halt within the first predefined period of time, prior to the transmission of the vehicle being put in park, the engine of the vehicle being turned off and a person remaining onboard the vehicle. In this embodiment, in an instance in which each of the foregoing events is detected in this predefined order, the resulting sequence of events indicates that the door of the vehicle is likely to be subsequently opened.

As shown in block 74 of FIG. 6 and in response to detection of the at least one event, the apparatus 20 includes means, such as the processor 22 or the like, for causing the drone 40 to take an ameliorative action regarding the door of the vehicle being subsequently opened with the ameliorative action designed to reduce the risk to the bicyclist or other vehicle of being hit by the door of the vehicle. Further details regarding the manner in which the drone is caused to be positioned relative to the vehicle are described above in relation to the embodiment of FIG. 3. In relation to the ameliorative action that is taken, the apparatus, such as the processor, may be configured to cause the drone to be positioned relative to the vehicle, such as proximate the door of the vehicle, so as to provide an indication regarding the door of the vehicle being opened. Alternatively, the apparatus, such as the processor, may be configured to cause the drone to be positioned in the path of the bicyclist or other vehicle so as to provide an indication regarding the door of the vehicle being opened. As also described above in conjunction with the embodiment with FIG. 3 and as shown in block 70 of FIG. 6, the apparatus of this example embodiment may also include means, such as the processor, at least one sensor 28 or the like, for determining that a bicyclist or another vehicle is approaching the vehicle. In this example embodiment, the detection of at least one event is responsive to and contingent upon the determination that the bicyclist or another vehicle is approaching the vehicle. As described above and as also shown in block 76 of FIG. 6, the apparatus of an example embodiment also includes means, such as the processor, at least one sensor 28 or the like, for determining that the bicyclist or other vehicle has passed the parked vehicle. In response to determining that the bicyclist or other vehicle has passed the parked vehicle, the apparatus also includes means, such as the processor or the like, for causing the UAV to discontinue the ameliorative action taken by the drone, such as by discontinuing its positioning relative to the vehicle and return, for example, to its initial position. See block 78.

In another example embodiment, the part of the vehicle that moves into the path of the vehicle is the body of the vehicle itself, such as in an instance in which the vehicle pulls out of the parking space into the path of travel of the bicyclist or another vehicle. In this example embodiment, FIG. 7 depicts the operations performed, such as by the apparatus 20 of FIG. 2, in order to detect and to respond to at least one event indicative of a vehicle subsequently pulling, from a stationary position, out into a lane of travel. In this embodiment, the apparatus includes means, such as the processor 22, at least one sensor 28 or the like, for detecting at least one event indicative of a vehicle subsequently pulling, from a stationary position, out into a lane of travel. See block 82 of FIG. 7. In this regard, the at least one event occurs prior to the vehicle actually pulling into the lane of travel and serves to predict the subsequent movement of the vehicle so as to pull from a parking space into a lane of travel. A variety of events may be detected that are indicative, either individually or upon occurrence in a predefined sequence, of the vehicle pulling out into a lane of travel.

For example, the event may be the detection of a person onboard the vehicle 12, such as a driver, who may cause the vehicle to pull out from the parking space into a lane of travel. In order to detect the person onboard the vehicle, the sensor 28 may include an image sensor for capturing images of the vehicle and its interior with the apparatus 20, such as the processor 22, being configured to analyze the images to detect the person onboard the vehicle. Other events that may be indicative of the vehicle pulling out from a parking space into a lane of traffic include the transmission of the vehicle being in gear, the engine of the vehicle running and/or the brakes of the vehicle being released. In order to detect the state of the transmission, the engine and the brakes, one or more sensors, such as one or more sensors onboard the vehicle, may be configured to monitor the transmission, the engine and/or the brakes. In some embodiments, the length of time that the engine of the vehicle has been running may also be considered as an event indicative of the vehicle subsequently pulling out into a lane of travel in an instance in which the engine has been running for at least a predetermined amount of time. Additional events that may be indicative of the vehicle pulling out from a parking space into a lane of traffic include the steering wheel of the vehicle having been moved within a first predefined period of time and/or wheel(s) of the vehicle having been moved within the first predefined period of time. The first predefined period of time is a period of time immediately prior to the current time and is based upon the premise that the driver of a vehicle that is preparing to pull out of a parking space frequently turns the steering wheel which, in turn, causes wheel(s) of the vehicle to be correspondingly turned. In order to detect movement of the steering wheels and/or the wheel(s), one or more sensors, such as one or more sensors onboard the vehicle, may be configured to monitor the steering wheel and/or the wheel(s). Another event that may be indicative of the vehicle pulling out from a parking space into a lane of traffic includes a person having entered the vehicle within a second predefined period of time. The second predefined period of time is a period of time immediately prior to the current time and is based upon the premise that the driver or other occupant of a vehicle frequently enters the vehicle shortly before the vehicle pulls out of a parking space and into a lane of traffic. Various sensors may be utilized to determine the timing with which a person enters a vehicle including image sensors for capturing images of the vehicle over time that may then be analyzed by the apparatus, such as the processor, to determine the time at which a person entered the vehicle.

While any one or more of these events may be indicative of the vehicle subsequently pulling, from a stationary position, out into a lane of travel, the apparatus 20, such as the processor 22, of some embodiments may require a sequence of two or more events to occur, such as in a predefined order, in order to determine that the vehicle is likely to subsequently pull out from a parking space into a lane of travel. For example, a sequence of events indicative of the vehicle subsequently pulling, from a stationary position, into a lane of traffic may include a person having entered the vehicle within the first predefined period of time, prior to the transmission of the vehicle being put in gear and the steering wheel being turned. In this embodiment, in an instance in which each of the foregoing events is detected in this predefined order, the resulting sequence of events indicates that the vehicle is likely to subsequently pull, from a stationary position, out into a lane of traffic.

As described above in relation to FIG. 3 and as shown in block 84 of FIG. 7 and in response to detection of the at least one event, the apparatus 20 includes means, such as the processor 22 or the like, for causing the drone 40 to take action, such as by being positioned relative to the vehicle 12 or within the path of travel of an approaching bicyclist or other vehicle, so as to provide an indication regarding the vehicle being likely to subsequently pull, from a stationary position, out into a lane of traffic. As also described above in conjunction with the embodiment with FIG. 3 and as shown in block 80 of FIG. 7, the apparatus of this example embodiment may also include means, such as the processor, at least one sensor 28 or the like, for determining that a bicyclist or another vehicle is approaching the vehicle. In this example embodiment, the detection of at least one event is responsive to and contingent upon the determination that the bicyclist or another vehicle is approaching the vehicle. As described above and as also shown in block 86 of FIG. 7, the apparatus of an example embodiment also includes means, such as the processor, at least one sensor 28 or the like, for determining that the bicyclist or other vehicle has passed the parked vehicle. In response to determining that the bicyclist or other vehicle has passed the parked vehicle, the apparatus also includes means, such as the processor or the like, for causing the drone to discontinue the action that was taken, such as by discontinuing its positioning relative to the vehicle and/or the approaching bicyclist or other vehicle and return, for example, to its initial position. See block 88.

A method, apparatus 20 and computer program product are therefore provided in accordance with an example embodiment in order to detect a least one event indicative of a part of a vehicle moving into the path of travel of a bicyclist or other vehicle and, in response to the detection the at least one event, to cause a drone 40 to take some action, such as by being positioned relative to the vehicle or relative to the approaching bicyclist or other vehicle. The drone provides an indication, either solely as a result of its position or as a result of its position in combination with a visible, audible or other output, regarding movement of the vehicle into the path of travel of the bicyclist or other vehicle. Based upon the indication provided by the drone, the bicyclist, the driver of the other vehicle and/or the driver of the vehicle that was previously parked may be forewarned such that evasive action may be taken, if necessary, at an earlier stage and in a more calculated manner so as to reduce the risk of a traffic accident.

FIGS. 3 and 5-7 illustrate flowcharts depicting methods according to an example embodiment of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, while the various embodiments have been described in conjunction with vehicles that are manually driven, the method, apparatus 20 and computer program product of an alternative embodiment operates in conjunction with one or more motorized vehicles that operate autonomously or semi-autonomously. For example, the vehicle 12 that is parked and that is being investigated to determine whether a part of the vehicle is anticipated to pull into the path of travel of a bicyclist or other vehicle may be an autonomous or semi-autonomous vehicle. Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
detecting at least one event indicative of a door of a vehicle being opened into a path of a bicyclist or another vehicle; and
responsive to detection of the at least one event, causing an unmanned drone to take an ameliorative action.

2. A method according to claim 1 wherein causing the unmanned drone to take an ameliorative action comprises causing the drone to be positioned relative to the vehicle so as to provide an indication regarding the door of the vehicle being opened.

3. A method according to claim 2 wherein causing the drone to be positioned relative to the vehicle comprises causing the drone to be positioned proximate the door of the vehicle.

4. A method according to claim 1 wherein causing the unmanned drone to take an ameliorative action comprises causing the drone to be positioned in the path of the bicyclist or another vehicle so as to provide an indication regarding the door of the vehicle being opened.

5. A method according to claim 1 wherein detecting at least one event indicative of the door of the vehicle being opened comprises detecting the at least one event selected from the group consisting of: a person being onboard the vehicle, a transmission of the vehicle being in park, an engine of the vehicle being off, the vehicle having come to a halt within a first predefined period of time, a part of the vehicle being indicative of having been recently operated, lettering or signage on the vehicle indicative of the vehicle being a taxi, and a medallion, decal or sign carried by the vehicle indicative of the vehicle providing ride share services.

6. A method according to claim 1 further comprising:
causing the drone to move along with a bicyclist or another vehicle;
while the drone moves along with the bicyclist or the another vehicle, identifying one or more stationary vehicles along a route of the bicyclist or the another vehicle; and
responsive to identifying one or more stationary vehicles, causing the drone to move further in advance of the bicyclist or the another vehicle in order to detect the at least one event.

7. A method according to claim 6 wherein causing the drone to move further in advance of the bicyclist or another vehicle comprises causing the drone to travel alongside the one or more stationary vehicles and the method further comprises causing a first alert to be provided regarding the one or more stationary vehicles in advance of the bicyclist or another vehicle.

8. A method according to claim 7 further comprising detecting, while the drone travels alongside the one or more stationary vehicles, a first type of event indicative of a door of the one or more stationary vehicles being subsequently opened and causing a second alert, different than the first alert, to be provided in response to detection of the first type of event.

9. A method according to claim 8 further comprising detecting, while the drone travels alongside the one or more stationary vehicles, a second type of event indicative of the door of the one or more stationary vehicles being opened and causing a third alert, different than the first and second alerts, to be provided in response to detection of the second type of event.

10. An apparatus comprising at least one processor and at least one non-transitory memory including computer program code instructions stored therein, the computer program code instructions configured to, when executed by the at least one processor, cause the apparatus at least to:
detect at least one event indicative of a vehicle subsequently pulling, from a stationary position, out into a lane of traffic; and
responsive to detection of the at least one event, cause an unmanned drone to be positioned relative to the vehicle so as to provide an indication regarding the vehicle subsequently pulling out into the lane of traffic.

11. An apparatus according to claim 10 wherein the computer program code instructions configured to detect at least one event indicative of the vehicle subsequently pulling out into the lane of traffic comprise computer program code instructions configured to detect the at least one event selected from the group consisting of: a person being onboard the vehicle, a transmission of the vehicle being in gear, an engine of the vehicle running, brakes of the vehicle having been released, a steering wheel of the vehicle having been moved within a first predefined period of time and a wheel of the vehicle having been moved within the first predefined period of time.

12. An apparatus according to claim 10 wherein the computer program code instructions are further configured to, when executed by the at least one processor, cause the apparatus to:
cause the drone to move along with a bicyclist or another vehicle;
while the drone moves along with the bicyclist or the another vehicle, identify one or more stationary vehicles along a route of the bicyclist or the another vehicle; and
responsive to identifying one or more stationary vehicles, cause the drone to move further in advance of the bicyclist or the another vehicle in order to detect the one or more events.

13. An apparatus according to claim 12 wherein the apparatus is caused to cause the drone to move further in advance of the bicyclist or another vehicle by causing the drone to travel alongside the one or more stationary vehicles and to cause a first alert to be provided regarding the one or more stationary vehicles in advance of the bicyclist or another vehicle.

14. An apparatus according to claim 13 wherein the apparatus is caused to detect the at least one event by detecting the at least one event while the drone travels alongside the one or more stationary vehicles, and wherein the method further comprises causing a second alert, different than the first alert, to be provided in response to detection of the at least one event.

15. An apparatus according to claim 10 wherein the computer program code instructions configured to cause the drone to be positioned relative to the vehicle comprises computer program code instructions configured to cause the drone to be positioned proximate the door of the vehicle.

16. A computer program product comprising at least one non-transitory computer-readable storage medium having computer-executable program code instructions stored therein, the computer-executable program code instructions comprising program code instructions configured to:
detect at least one event indicative of a part of a vehicle moving into a path of a bicyclist, wherein the vehicle has a speed that is no greater than a predefined threshold; and
responsive to detection of the at least one event, cause an unmanned drone to be positioned relative to the vehicle so as to provide an indication regarding the vehicle moving into the path of the bicyclist.

17. A computer program product according to claim 16 wherein the program code instructions configured to detect the at least one event comprises program code instructions configured to detect the at least one event indicative of a door of the vehicle being opened.

18. A computer program product according to claim 17 wherein the at least one event indicative of the door of the vehicle being opened comprises detecting the at least one event selected from the group consisting of: a person being onboard the vehicle, a transmission of the vehicle being in park, an engine of the vehicle being off, the vehicle having come to a halt within a first predefined period of time, a part of the vehicle being indicative of having been recently operated lettering or signage on the vehicle indicative of the vehicle being a taxi, and a medallion, decal or sign carried by the vehicle indicative of the vehicle providing ride share services.

19. A computer program product according to claim 16 wherein the program code instructions configured to detect the at least one event comprises program code instructions configured to detect the at least one event indicative of the vehicle subsequently pulling out into path of the bicyclist.

20. A computer program product according to claim 19 wherein the at least one event indicative of the vehicle subsequently pulling out into the path of the bicyclist comprises detecting the at least one event selected from the group consisting of: a person being onboard the vehicle, a transmission of the vehicle being in gear, an engine of the vehicle running, brakes of the vehicle having been released, a steering wheel of the vehicle having been moved within a first predefined period of time, a wheel of the vehicle having been moved within the first predefined period of time and a person having entered the vehicle within a second predefined period of time.
